(19) United States
(12) Patent Application Publication
(10) Pub. No.: US 2022/0371865 A1
(43) Pub. Date: Nov. 24, 2022

(54) Vehicle Jacking Assembly

(71) Applicant: David A. Horn, Reno, NV (US)

(72) Inventor: David A. Horn, Reno, NV (US)

(21) Appl. No.: 17/324,727

(22) Filed: May 19, 2021

(51) Int. Cl. B66F 5/04

(52) U.S. Cl. CPC B66F 5/04

(57) ABSTRACT

A vehicle jacking assembly for lifting a vehicle for performing maintenance thereon includes a housing, which defines an interior space and which is can be positioned on a surface below a frame of a vehicle. A pneumatic bag is engaged to the housing and is selectively extensible therefrom through an aperture positioned in a top of the housing. A compressor and a battery are engaged to the housing and positioned in the interior space. The compressor is operationally engaged to the pneumatic bag. The battery is operationally engaged to the compressor. The battery is positioned to selectively power the compressor to inflate the pneumatic bag so that the pneumatic bag extends from the housing and contacts the frame of the vehicle to lift a corner or side of the vehicle.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to jacking assemblies and more particularly pertains to a new jacking assembly for lifting a vehicle for performing maintenance thereon. The present invention discloses a jacking assembly that is wheeled and which has a telescopic handle for motivating the jacking assembly upon a surface. The disclosed jacking assembly also comprises an integral compressor and a set of bulbs, with the latter being capable of selectively illuminating an underside of the vehicle proximate to the jacking assembly.

### (2) Description of Related Art Including Information Disclosed Under 37 CFR 1.97 and 1.98

The prior art relates to jacking assembly. Prior art jacking assemblies may comprise pneumatic bags, which are selectively engageable to an external compressor. What is lacking in the prior art is a jacking assembly that is wheeled and which has a telescopic handle for motivating the jacking assembly upon a surface. Additionally, prior art jacking assemblies lack an integral compressor and a set of bulbs, with the latter being capable of selectively illuminating an underside of a vehicle proximate to the jacking assembly.

### BRIEF SUMMARY OF THE INVENTION

An embodiment of the disclosure meets the needs presented above by generally comprising a housing, which defines an interior space and which is configured to be positioned on a surface below a frame of a vehicle. A pneumatic bag is engaged to the housing and is selectively extensible therefrom through an aperture positioned in a top of the housing. A compressor and a battery are engaged to the housing and positioned in the interior space. The compressor is operationally engaged to the pneumatic bag. The battery is operationally engaged to the compressor. The battery is positioned to selectively power the compressor to inflate the pneumatic bag so that the pneumatic bag extends from the housing and contacts the frame of the vehicle. The pneumatic bag thus is configured to lift a corner or side of the vehicle.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric perspective view of a vehicle jacking assembly according to an embodiment of the disclosure.

FIG. 2 is an isometric perspective view of an embodiment of the disclosure.

FIG. 3 is a top view of an embodiment of the disclosure.

FIG. 4 is a bottom view of an embodiment of the disclosure.

FIG. 5 is a cross-sectional view of an embodiment of the disclosure.

FIG. 6 is a cross-sectional view of an embodiment of the disclosure.

FIG. 7 is an in-use view of an embodiment of the disclosure.

### DETAILED DESCRIPTION OF THE INVENTION

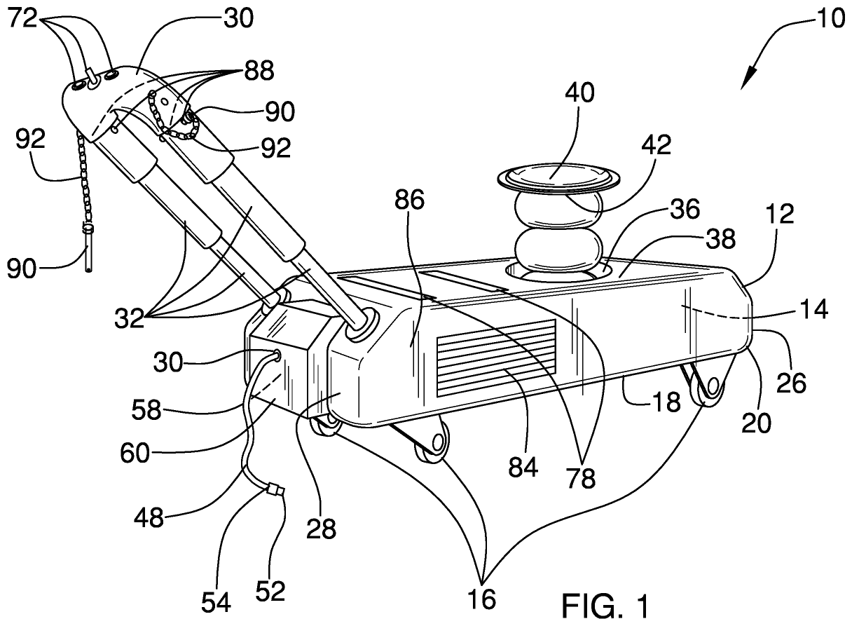

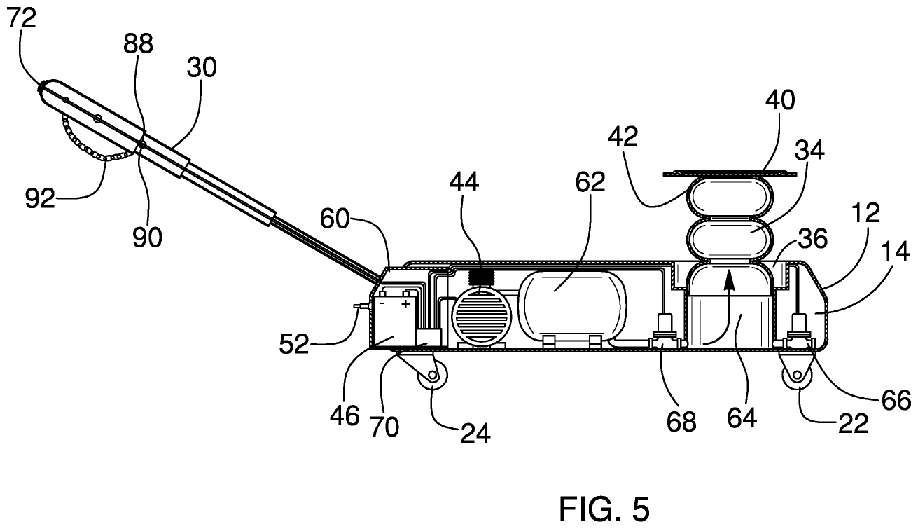

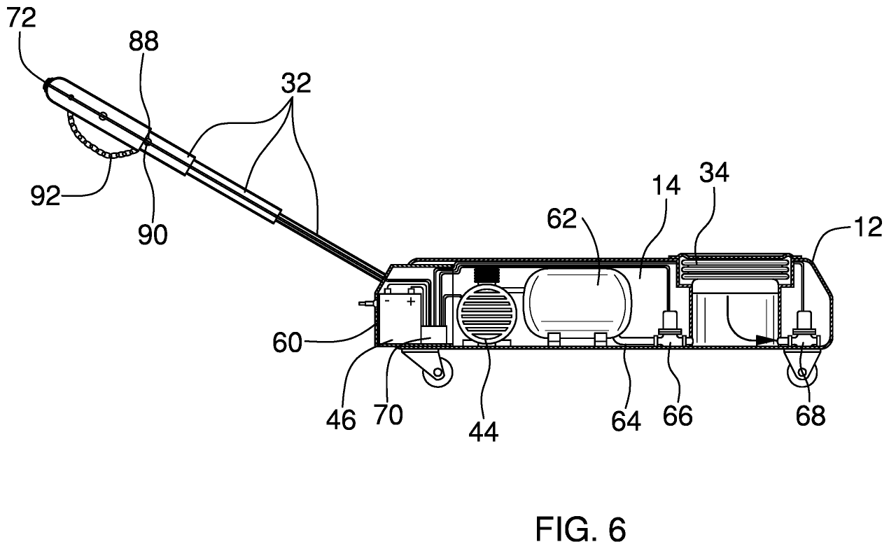

With reference now to the drawings, and in particular to FIGS. 1 through 7 thereof, a new jacking assembly embodying the principles and concepts of an embodiment of the disclosure and generally designated by the reference numeral 10 will be described.

As best illustrated in FIGS. 1 through 7, the vehicle jacking assembly 10 generally comprises a housing 12, which defines an interior space 14 and which is configured to be positioned on a surface below a frame of a vehicle. A set of wheels 16 is engaged to a bottom 18 of the housing 12, with each wheel 16 being positioned proximate to a respective corner 20 of the housing 12. The wheels 16 are configured to allow locomotion of the housing 12 on a surface. The set of wheels 16 comprises a pair of forward castors 22 and a pair of rearward castors 24, which are engaged to the housing 12 proximate to a front 26 and a back 28 thereof, respectively. The rearward castors 24 are rotationally engaged to the housing 12 so that the housing 12 is steerable.

A handle 30 is engaged to the back 28 of the housing 12. The handle 30 comprises a plurality of nested sections 32 so that the handle 30 is selectively extensible from the housing 12. The handle 30 is configured to be grasped in a hand of a user to locomote the housing 12 upon the wheels 16.

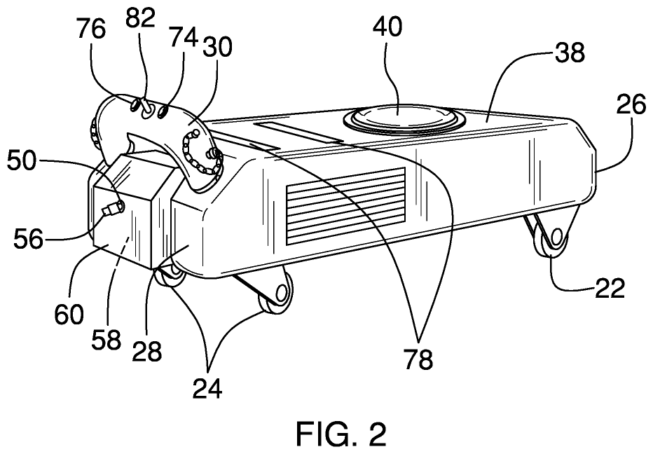

A pneumatic bag 34 is engaged to the housing 12 and is selectively extensible therefrom through an aperture 36 positioned in a top 38 of the housing 12, as shown in FIG. 2. The aperture 36 is biased toward the front 26 of the housing 12 relative to the back 28 of the housing. A plate 40 is engaged to an upper end 42 of the pneumatic bag 34. The plate 40 is configured to contact the frame of the vehicle as the pneumatic bag 34 is inflated. The plate 40 is disc shaped so that the plate 40 is shaped complementarily to the upper end 42 of the pneumatic bag 34. The pneumatic bag 34 is one of a set of pneumatic bags 34, which are fluidically interconnected and stacked perpendicularly to the top 38 of the housing 12. The pneumatic bags 34 are sequentially inflatable.

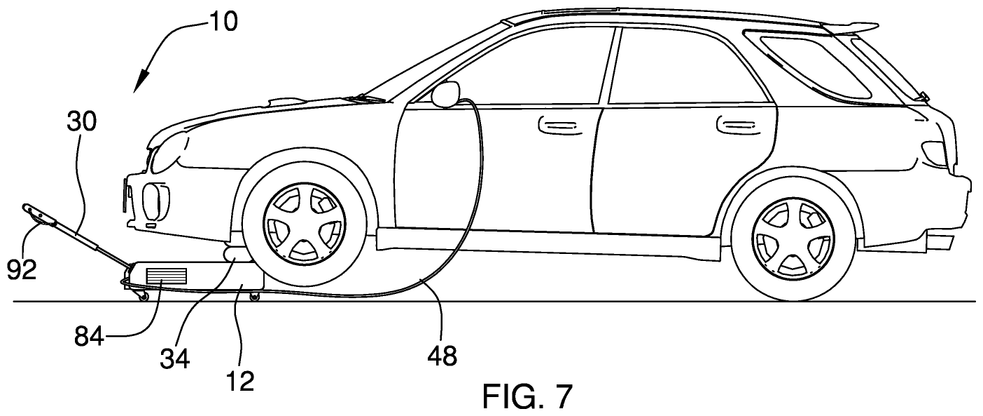

A compressor 44 and a battery 46 are engaged to the housing 12 and are positioned in the interior space 14. The compressor 44 is operationally engaged to the pneumatic bag 34. The battery 46 is operationally engaged to the compressor 44. The battery 46 is positioned to selectively power the compressor 44 to inflate the pneumatic bag 34 so that the pneumatic bag 34 extends from the housing 12 and contacts the frame of the vehicle. The pneumatic bag 34 thus is configured to lift a corner or side of the vehicle, as shown in FIG. 7. The assembly 10 can be utilized by a user to lift the vehicle to perform maintenance, such as replacing a wheel having a flattened tire.

The battery 46 is rechargeable. A cord 48 is operationally engaged to the battery 46 and the compressor 44. The cord 48 is selectively extensible from the housing 12 through a hole 50 positioned in the back 28 of the housing 12. A connector 52 is engaged to a terminus 54 of the cord 48. The cord 48 thus is configured to operationally engage the battery 46 to a source of electrical current to charge the battery 46 and to power the compressor 44. The connector 52 comprises a cigarette lighter plug (not shown), a Universal Serial Bus plug 56, or the like.

The housing 12 has a cutout 58 positioned in the back 28 thereof. A box 60 is selectively insertable into the housing 12 through the cutout 58 so that the box 60 is removably engageable to the housing 12. The battery 46 is positioned in the box 60 so that the battery 46 is selectively removable from the housing 12 for servicing of the battery 46.

A tank 62 is engaged to the housing 12 and positioned in the interior space 14. The tank 62 is operationally engaged to the compressor 44 and the pneumatic bag 34 so that the compressor 44 is positioned to selectively compress air into the tank 62. A pipe 64 is engaged to the bottom 18 of the housing 12 and extends toward the aperture 36. The pneumatic bag 34 is engaged to the pipe 64 distal from the bottom 18 of the housing 12 so that the pneumatic bag 34 is in fluidic communication with the tank 62.

A first valve 66 is engaged to the housing 12 and positioned in the interior space 14. The first valve 66 is operationally engaged to the tank 62 and the pipe 64 so that the first valve 66 is in fluidic communication with the tank 62 and the pipe 64. The first valve 66 is configured to selectively and fluidically engage the tank 62 to the pipe 64 to inflate the pneumatic bag 34.

A second valve 68 is engaged to the housing 12 and positioned in the interior space 14. The second valve 68 is operationally engaged to the pipe 64 so that the second valve 68 is in fluidic communication with the pipe 64 and the interior space 14. The valve is configured to selectively fluidically engage the pipe 64 to the interior space 14 to deflate the pneumatic bag 34.

A controller 70 is engaged to the housing 12 and positioned in the interior space 14. The controller 70 is operationally engaged to the battery 46, the compressor 44, the first valve 66, and the second valve 68. The controller 70 is positioned to selectively actuate the compressor 44 and the first valve 66 to inflate the pneumatic bag 34. The controller 70 also is positioned to selectively deactuate the first valve 66 and to actuate the second valve 68 to deflate the pneumatic bag 34.

A control panel 72 is engaged to the handle 30 and is operationally engaged to the controller 70. The control panel 72 is configured to signal the controller 70 to selectively inflate and deflate the pneumatic bag 34. The control panel 72 may comprise a first button 74 and a second button 76, or other controlling means, such as, but not limited to, toggle switches, dials, and the like. The first button 74 and the second button 76 are depressible. The first button 74 is configured to be depressed to signal the controller 70 to inflate the pneumatic bag 34. The second button 76 is configured to be depressed to signal the controller 70 to deflate the pneumatic bag.

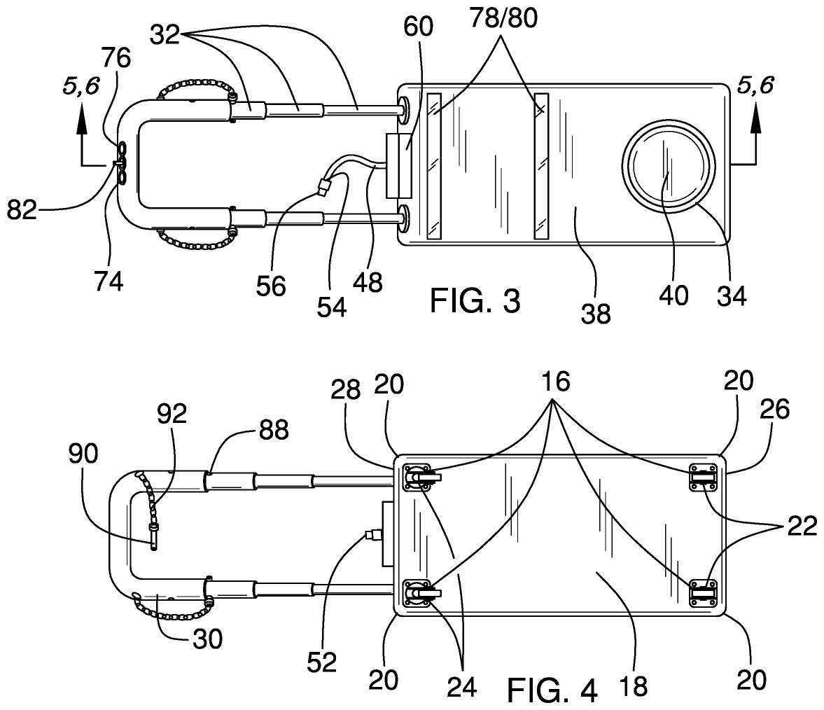

A set of bulbs 78 is engaged to the top 38 of the housing 12 and is operationally engaged to the battery 46 so that the battery 46 is positioned to selectively power the bulbs 78. The bulbs 78 are configured to selectively illuminate an underside of the vehicle proximate to the housing 12. The set of bulbs 78 comprises a pair of light emitting diode strips 80, which are positioned singly proximate to the front 26 and the back 28 of the housing 12, as shown in FIG. 3. The control panel 72 comprises a switch 82, which is operationally engaged to the set of bulbs 78. The switch 82 is configured to be switched to selectively power the set of bulbs 78.

The housing 12 may have a pair of voids 84 positioned therein for venting the interior space 14. The voids are positioned singly in opposed sides 86 of the housing 12, proximate to the back 28 of the housing. The voids 84 may be louvered, as shown in FIG. 2, so as to prevent insertion of objects, hands, or the like, through the voids 84 into the interior space 14.

The handle 30 may have a set of pinholes 88 positioned therein, such that respective nested sections 32 each have a pinhole 88 positioned therein. The pinholes 88 positioned in adjacently positioned nested sections 32 are aligned with the adjacently positioned nested sections 32 in an extended configuration, as shown in FIG. 1. With the pinholes 88 thus aligned, they are positioned for insertion of a pin 90 to prevent the adjacently positioned nested sections 32 from assuming a nested configuration. The pin 90 may be engaged to the handle 30 by means of a chain 92 to prevent loss of the pin 90 when not in use.

In use, the housing 12 is pushed beneath the vehicle so that the plate 40 is aligned with the frame of the vehicle. The first button 74 is depressed to signal the controller 70 to inflate the pneumatic bag 34 so that the plate 40 contacts the frame and the vehicle is lifted. Upon obtaining a desired lift of the vehicle, the first button 74 is released. The user then can perform maintenance on the vehicle, and, when the maintenance is completed, press the second button 76 to deflate the pneumatic bag 34 and lower the vehicle. To charge the battery 46, or to power the compressor 44 in event the battery 46 is depleted, the cord 48 can be used to charge the battery 46 and to power the compressor 44.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the elements is present, unless the context clearly requires that there be only one of the elements.

1. A vehicle jacking assembly comprising:
a housing defining an interior space and being configured for positioning on a surface below a frame of a vehicle, the housing having an aperture positioned in a top thereof;
a pneumatic bag engaged to the housing and being selectively extensible therefrom through the aperture;
a compressor engaged to the housing and positioned in the interior space, the compressor being operationally engaged to the pneumatic bag; and
a battery engaged to the housing and positioned in the interior space, the battery being operationally engaged to the compressor, such that the battery is positioned for selectively powering the compressor for inflating the pneumatic bag, such that the pneumatic bag extends from the housing and contacts the frame of the vehicle, wherein the pneumatic bag is configured for lifting a corner or side of the vehicle.

2. The vehicle jacking assembly of claim 1, further including:
a set of wheels engaged to a bottom of the housing, each wheel being positioned proximate to a respective corner of the housing, wherein the wheels are configured for locomoting the housing on a surface; and
a handle engaged to a back of the housing, the handle comprising a plurality of nested sections such that the handle is selectively extensible from the housing, wherein the handle is configured for grasping in a hand of a user for locomoting the housing upon the wheels.

3. The vehicle jacking assembly of claim 1, wherein the set of wheels comprises a pair of forward castors and a pair of rearward castors engaged to the housing proximate to a front and a back thereof, respectively, the rearward castors being rotationally engaged to the housing, such that the housing is steerable.

4. The vehicle jacking assembly of claim 1, wherein the pneumatic bag is one of a set of pneumatic bags, the pneumatic bags of the set of pneumatic bags being fluidically interconnected and stacked perpendicularly to the top of the housing, such that the pneumatic bags are sequentially inflatable.

5. The vehicle jacking assembly of claim 1, further including:
the battery being rechargeable;
a cord operationally engaged to the battery and the compressor, the cord being selectively extensible from the housing through a hole positioned in a back thereof; and
a connector engaged to a terminus of the cord, such that the cord is configured for operationally engaging the battery to a source of electrical current for charging the battery and for powering the compressor.

6. The vehicle jacking assembly of claim 5, wherein the connector comprising a cigarette lighter plug or a Universal Serial Bus plug.

7. The vehicle jacking assembly of claim 1, further including:
the housing having a cutout positioned in a back thereof; and
a box selectively insertable into the housing through the cutout, such that the box is removably engageable to the housing, the battery being positioned in the box, such that the battery is selectively removable from the housing for servicing the battery.

8. The vehicle jacking assembly of claim 1, further including:
a tank engaged to the housing and positioned in the interior space, the tank being operationally engaged to the compressor and the pneumatic bag, such that the compressor is positioned for selectively compressing air into the tank;
a pipe engaged to the bottom of the housing and extending toward the aperture, the pneumatic bag being engaged to the pipe distal from the bottom of the housing, such that the pneumatic bag is in fluidic communication with the tank;
a first valve engaged to the housing and positioned in the interior space, the first valve being operationally engaged to the tank and the pipe, such that the first valve is in fluidic communication with the tank and the pipe, wherein the first valve is configured for selectively fluidically engaging the tank to the pipe for inflating the pneumatic bag; and
a second valve engaged to the housing and positioned in the interior space, the second valve being operationally engaged to the pipe, such that the second valve is in fluidic communication with the pipe and the interior space, wherein the second valve is configured for selectively fluidically engaging the pipe to the interior space for deflating the pneumatic bag.

9. The vehicle jacking assembly of claim 8, further including a controller engaged to the housing and positioned in the interior space, the controller being operationally engaged to the battery, the compressor, the first valve, and the second valve, such that the controller is positioned for selectively actuating the compressor and the first valve for inflating the pneumatic bag, and such that the controller is positioned for selectively deactuating the first valve and actuating the second valve for deflating the pneumatic bag.

10. The vehicle jacking assembly of claim 9, further including:
a set of wheels engaged to a bottom of the housing, each wheel being positioned proximate to a respective corner of the housing, wherein the wheels are configured for locomoting the housing on a surface; and
a handle engaged to the back of the housing, the handle comprising a plurality of nested sections such that the handle is selectively extensible from the housing, wherein the handle is configured for grasping in a hand of a user for locomoting the housing upon the wheels; and
a control panel engaged to the handle and being operationally engaged to the controller, wherein the control panel is configured for signaling the controller for selectively inflating and deflating the pneumatic bag.

11. The vehicle jacking assembly of claim 10, wherein the control panel comprises a first button and a second button, the first button and the second button being depressible, wherein the first button is configured for being depressed for signaling the controller for inflating the pneumatic bag, wherein the second button is configured for being depressed for signaling the controller for deflating the pneumatic bag

12. The vehicle jacking assembly of claim 10, further including:
a set of bulbs engaged to the top of the housing and being operationally engaged to the battery, such that the battery is positioned for selectively powering the set of bulbs, wherein the bulbs are configured for selectively illuminating an underside of the vehicle proximate to the housing; and
the control panel comprising a switch, the switch being operationally engaged to the set of bulbs, wherein the switch is configured for switching for selectively powering the set of bulbs.

13. The vehicle jacking assembly of claim 12, wherein the set of bulbs comprises a pair of light emitting diode strips positioned singly proximate to the front and the back of the housing.

14. The vehicle jacking assembly of claim 1, further including r engaged to an upper end of the pneumatic bag, wherein the plate is configured for contacting the frame of the vehicle as the pneumatic bag is inflated.

15. The vehicle jacking assembly of claim 1, wherein the plate is disc shaped, such that the plate is shaped complementarily to the upper end of the pneumatic bag.
